(19) United States
(12) Patent Application Publication
(10) Pub. No.: US 2026/0253873 A1
(43) Pub. Date: Aug. 27, 2026

(54) ANODE ACTIVE MATERIAL PARTICLES ENCAPSULATED IN PYROGENIC, NANOSTRUCTURED MAGNESIUM OXIDE, AND METHODS OF MAKING AND USING THE SAME

(71) Applicant: Evonik Operations GmbH, Essen (DE)

(72) Inventors: Daniel Esken, Erlensee (DE); Christian Hofmann, Schluechtern (DE); Daniel Dehe, Bruchkoebel (DE); Franz Schmidt, Gross-Gerau (DE); Ryo Takata, Shanghai (CN)

(73) Assignee: Evonik Operations GmbH, Essen (DE)

(21) Appl. No.: 18/870,500

(22) PCT Filed: May 24, 2023
(86) PCT No.: PCT/EP2023/063936

§ 371 Date: Nov. 29, 2024

(30) Foreign Application Priority Data
Jun. 3, 2022 (EP) 22177289.0

(51) Int. Cl. H01M 4/36; H01M 4/02; H01M 4/04; H01M 10/0525; H01M 10/54

(52) U.S. Cl. CPC H01M 4/364; H01M 4/0471; H01M 10/0525; H01M 10/54; H01M 2004/021; H01M 2004/027

(57) ABSTRACT

A process for producing a coated active anode material starts with dry mixing a mixed anode material and a pyrogenically produced, nanostructured magnesium oxide in a mixing unit having a specific electrical power of 0.05-1.5 KW per kg of the mixed anode material. The coated mixed anode material finds application in lithium-ion batteries, electric and/or electronic devices.

### FIELD OF THE INVENTION

The invention relates to a method of producing encapsulated anode active material particles in which carbon and/or Si-based particles and fumed, nanostructured magnesium oxide are mixed dry under shearing conditions. The invention further relates to the fumed magnesium oxide coated anode material as well as to a battery cell containing the encapsulated carbon and/or Si-based anode particles and to the use thereof.

### BACKGROUND OF THE INVENTION

Various energy storage technologies have recently attracted much attention of public and have been a subject of intensive research and development at the industry and in the academia. As energy storage technologies are extended to devices such as cellular phones, camcorders and notebook PCs, and further to electric vehicles, demand for high energy density batteries used as a source of power supply of such devices is increasing. Secondary lithium-ion batteries are one of the most important battery types currently used.

A secondary lithium-ion battery is typically composed of an anode made, for example, of a carbon material or a lithium-metal alloy, a cathode made, for example, of a lithium-metal oxide, and an electrolyte, for example a lithium salt dissolved in an organic solvent. The separator of the lithium-ion battery provides passage of lithium ions between the cathode and the anode during the charging and discharging of the battery.

US patent application publication 2019/0393543 describes a lithium metal secondary battery, comprising a cathode, an anode, and a porous separator or electrolyte disposed between the cathode and the anode, wherein the anode comprises (a) an anode active layer containing a layer of lithium or lithium alloy, in a form of a foil, coating, or multiple particles aggregated together, as an anode active material, and (b) an anode-protecting layer of a conductive sulfonated elastomer composite, disposed between the anode active layer and the separator/electrolyte.

US patent application publication 2019/363345 describes forming a protective coating of graphene on a negative lithium metal electrode, for lithium-ion batteries. The graphene protective coating is said to reduce dendrite growth.

International application publication WO2019215406A1 describes an anode for a lithium-ion battery, including at least one anode material coated with a protective coating including a very long list of allegedly suitable materials, however, neither the materials nor the process of the present invention disclosure are disclosed therein.

Chinese patent application publication CN106025242A describes a composite anode material for a lithium-ion battery comprising a core layer of a porous silicon alloy nanowire with carbon nanotubes and a shell layer made of a conductive polymer film of a polypropylene oxide, polyethylene succinate, polyethylene succinate, or polyethylene glycol imine blended with graphene.

Generally, coating of cathode materials of lithium-ion batteries with metal oxides, such as, for example, Al₂O₃, TiO₂, ZrO₂ and MgO for improving cycling performance has been described in the literature.

Some examples of use of MgO in anode materials are provided in the following articles. In the article entitled “Homogenizing Silicon Domains in SiOx Anode during Cycling and Enhancing Battery Performance via Magnesium Doping” published in ACS Appl. Mater. Interfaces 2021, 13, 52202-52214 by Han et al. magnesium was used as dopant for an SiOx anode active material. However, modification and reaction of the components to finally form a protective Mg-silicate compound requires temperatures above 1000° C.

In the article entitled “Improvement of cycling performance of lithium-sulfur batteries by using magnesium oxide as a functional additive for trapping lithium polysulfide” of Ponraj et al. published in ACS Appl. Mater. Interfaces 2016, 8, 4000-4006, hydrophilic magnesium oxide was used as an additive on the surface of the active sulfur of sulfur-positive electrodes to trap polysulfides.

Also, generally, elements like carbon and its allotropes (graphene) have been used as anode materials in lithium-ion secondary batteries, however, there exist several issues with their structural stability. In an article entitled “An electrode comprising of graphene nano-powder inserted in an enclosed structure in anodic aluminum oxide coated with polyaniline by using low temperature hydrothermal process” of Sugam et al. published in 1942, 1, 62nd DAE Solid State Physics Symposium, 2017, graphene nano-powder was inserted and confined on an anodic aluminum oxide coated using polyaniline.

In the article entitled “An Alumina-Coated Fe3O4-Reduced Graphene Oxide Composite Electrode as a Stable Anode for Lithium-ion Battery” of Qi-Hui et al. published in Electrochimica Acta (2015), 156, 147-153, an Al₂O₃ coating was used on a Fe₃O₄-reduced graphene oxide composite anodic material.

CN 103 441 252 discloses a lithium-rich anode active material coated with nano-sized magnesium oxide.

In the article “Nanocrystalline NiO thin film anode with MgO coating for Li-ion batteries” of Wang et al. published in Electrochimica Acta (2003), vol. 48, no. 28, pages 4253-4259, the formation of nanocrystalline NiO thin films by pulsed laser reactive ablation in an oxygen ambient and subsequent coating by MgO on the NiO film surface.

Wang Bo et al. published in “Rational formation of solid electrolyte interface for high-rate potassium ion batteries” in Nano Energy, vol. 75 (2020), page 104979, the synthesis of a P—S co-doped flexible carbon fiber film which is self-contained with SiO₂ and MgO nanoparticles,

A rather major general problem with anode materials, especially silicon-based anode materials, is the uncontrolled solid electrolyte interface (SEI) formation during initial charge-discharge processes of a battery. In addition, aging processes within the bulk of the material result in the loss of performance during cycling. This aging phenomenon is especially relevant for Si-based anode active materials. During cycling the negative electrode material suffers from several electrochemical degradation mechanisms. The deactivation of the negative electrode material occurs by several electrochemical degradation mechanisms. Electrolyte induced surface transformations and unwanted side reactions with lithium species lead to the formation of SEI layers with increased thickness, finally resulting in a decreased performance and battery lifetime.

Surface coating has proven to be an extremely important method to address this aging problem by suppressing the direct contact between the active materials surfaces and the liquid electrolyte.

Although nano-sized MgO particles have been used as additives in lithium-ion batteries their effectiveness is limited by poor dispersibility. Practical ways to improve the batteries long life are often limited. Thus, in the case of magnesium oxide, the use of commercially available nano-sized MgO particles often leads to inhomogeneous distribution and large agglomerated MgO particles on the surface of the anode materials such as, for example, carbon and/or Si-based materials. As a result, the anode material particles are not fully covered by the magnesium oxide particles and large non-dispersed magnesium oxide particles are present and located next to the anode particles clearly visible by SEM elemental mapping.

The problem addressed by the present invention is that of providing a homogeneous coating layer of a metal oxide around carbon and/or Si-based particles made by the dry coating of the powders.

In the course of thorough experimentation, it was surprisingly found that pyrogenically produced, nanostructured magnesium oxide can be used successfully for the homogeneous coating of anode material, such as carbon and/or Si-based particles using a dry mixing process for coating the magnesium oxide on the anode materials. It was also surprisingly found that further surface modification of the pyrogenically produced, nanostructured magnesium oxide prior to the dry mixing may further improve the coverage and homogeneity of the coating significantly.

### SUMMARY OF THE INVENTION

The invention provides a process for producing a coated active anode material, the coated active anode material, and the use of the coated active anode material in a lithium-ion battery. The lithium-ion battery of the present invention can be used in electronic and electrical apparatuses including, for example, mobile phones, computers (lap top computers, desk top computers, computer pads), electronic watches, key fabs, electric appliances, power tools, vacuum cleaners, electric lawn mowers and electric vehicles.

According to a first aspect of the present invention there is provided a process for producing a coated active anode material. The process is characterized in that the coated active anode material is obtained by subjecting an active anode material and a pyrogenically produced magnesium oxide to dry mixing in a mixing unit under shearing conditions, wherein the coated active anode material is in the form of particles, and the magnesium oxide has a BET surface area of 5-300 m²/g (DIN 9277:2014), a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

The pyrogenically produced MgO is hydrophilic. Preferably, in an embodiment, the pyrogenically produced MgO is subjected to a surface modification to become hydrophobic.

In an embodiment, the mixing unit has a specific electrical power of 0.05-1.5 KW per kg of the mixed anode material.

The coated active anode material is in the form of particles, and the magnesium oxide has a BET surface area of 5-300 m²/g, a mono-modally and narrow particle size distribution with a mean aggregate diameter d₅₀ of 5-150 nm, more preferably 10-120 nm, even more preferably 20-100 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

In an embodiment, the process is characterized in that the specific electrical power of the mixing unit is 0.1-1000 KW, the volume of the mixing unit is 0.1 L to 2.5 m³, and the speed of a mixing tool in the mixing unit is 5-30 m/s.

The span (d₉₀−d₁₀)/d₅₀ of particles of the magnesium oxide and/or of the mixed oxide comprising magnesium is 0.4-1.2, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

The active anode material comprises carbon and/or Si-based particles. Si-based particles as this term is used herein means silicon particles (e.g., pure silicon particles), silicon oxide (SiOx) particles, and any combinations of silicon, silicon oxide, and carbon particles including mixtures and composites thereof. Silicon oxide can be SiO and/or SiO₂.

In an embodiment, the coated active anode material is further subjected to a heat treatment following the dry mixing.

In an embodiment, the proportion of the magnesium oxide in the coated active anode material is 0.05%-5% by weight, based on the total weight of the coated mixed anode material.

Another aspect of the present invention is directed to the coated active anode material obtainable by the above process.

According to yet another aspect of the present invention there is provided a coated active anode material comprising an active anode material and a coating of a pyrogenically produced, nanostructured magnesium oxide on the surface of the mixed anode material, wherein the coated active anode material is in the form of particles, and the magnesium oxide has a BET surface area of 5-300 m²/g (DIN 9277:2014), a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water and wherein the pyrogenically produced, nanostructured magnesium oxide is preferably surface treated to become hydrophobic by reaction of the hydroxyl groups of the MgO with a silane to form —O—Si—R groups. The magnesium oxide is hydrophilic or hydrophobic, preferably hydrophobic. The active anode material is carbon, silicon, silicon oxide (SiOx), or any combinations thereof including mixtures and/or composites of carbon, silicon, and silicon oxide.

The SEM-EDX mapping of the coated active anode material provides a fully and homogeneous coverage of the pyrogenically produced MgO substantially around all anode particles, with no or only few larger magnesium oxide agglomerates.

Other aspects of the present invention, are directed to an active negative electrode material for a lithium-ion battery comprising the coated active anode material, also to a lithium-ion battery comprising the coated active anode material, and also to the use of the coated active anode material in an active negative electrode material of a lithium-ion battery.

Yet another aspect of the present invention is directed to an apparatus powered by the lithium-ion battery.

The nanostructured magnesium oxide made by the flame process has a mono-modally and narrow particle size distribution in combination with an excellent dispersibility during the dry coating process of the anode material. These particles lead to an excellent interaction and proper adhesion to the anode active material.

Furthermore, the additional surface modification of these particles leads to further improvements in interaction and adhesion to the anode active material. This results in a complete de-agglomeration of the magnesium oxide agglomerates and finally provide a fully and homogenously covered anode active material particles by the fumed, nanostructured and surface modified magnesium oxide.

It has been found that by using a high intensity dry coating process in combination with the pyrogenic, nanostructured MgO particles, the present invention method results in significantly improved dispersibility of the MgO particles and homogeneous coating. During the dry mixing, the applied shear forces (mixing) decompose any MgO agglomerates into tiny aggregates which have a very high tendency to settle down on the surface of the anode active material particles powder resulting in very good interaction and adhesion which in turn results in a homogeneous coating. In contrast, conventional MgO particles, which are not pyrogenically produced and nanostructured, are composed of isolated, spherical particles (which are the result of milling coarser MgO particles) and do not show such behaviour.

These and other features and advantages of the invention will become better understood from the following detailed description in conjunction with the following figures.

### BRIEF DESCRIPTION OF THE DRAWINGS

FIG. 1(a) shows the particle size distribution of a pyrogenically produced, nanostructured, hydrophilic magnesium oxide according to an embodiment of the present invention.

FIG. 1(b) shows the particle size distribution of a conventional non-fumed magnesium oxide.

FIG. 2(a) shows the SEM-EDX mapping of the pyrogenically produced, nanostructured, hydrophilic magnesium oxide of FIG. 1(a) coated on an anode active material, according to an embodiment of the present invention.

FIG. 2(b) shows the SEM-EDX mapping of a pyrogenically produced, nanostructured, and surface modified magnesium oxide coated on the anode active material according to an embodiment of the present invention.

FIG. 2(c) shows the SEM-EDX mapping of the non-fumed magnesium oxide of FIG. 1(b) coated on the anode active material as a comparative example.

FIG. 3 shows a lithium-ion battery inside an apparatus according to an embodiment of the present invention.

### DETAILED DESCRIPTION OF THE INVENTION

According to a first aspect of the invention there is provided a method of producing encapsulated active anode material particles in which an active anode material and fumed, nanostructured, and, preferably, also, surface modified magnesium oxide are dry mixed under shearing conditions. A second aspect of the invention relates to the fumed magnesium oxide coated anode material, and a third aspect of the invention relates to a battery cell containing the encapsulated carbon and/or Si-based anode particles.

### Process for Producing the Coated Anode Active Material

According to a first aspect of the present invention, there is provided a process for producing a coated active anode material, wherein carbon and/or Si-based anode particles and a pyrogenically produced, nanostructured, and preferably, surface modified magnesium oxide are subjected to dry mixing under shearing conditions. Si-based anode particles includes silicon particles, silicon oxide particles, and any combinations of silicon, silicon oxide, and carbon particles.

The fumed, nanostructured magnesium oxide is preferably also surface modified to become hydrophobic prior to the dry mixing.

The active anode material may be referred to also as the core active anode material or the substrate active anode material or particles. The pyrogenically produced, nanostructured and, preferably, surface modified MgO magnesium oxide may also be referred as the coating. The coated active anode material refers to the mixed active anode material with the coating produced by dry mixing. Once the dry mixing is completed the carbon and/or Si-based particles are covered with said MgO.

### Dry Mixing

Dry mixing may be performed, for example, in a mixing unit having a specific electrical power of 0.05-1.5 KW per kg of the mixed anode material. Dry mixing is understood to mean that no liquid is added or used during the mixing process, that is e.g., substantially dry powders are mixed together. However, it is possible that there are trace amounts of moisture or some other than water liquids present in the mixed feedstocks or that these include crystallization water.

If the used specific electrical power is less than 0.05 KW per kg of the mixed anode material, this gives an inhomogeneous distribution of the magnesium oxide on top of the anode active material particles, which may be not firmly bonded to the core material of the anode active material particles. A specific electrical power of more than 1.5 KW per kg of the mixed anode material leads to poorer electrochemical properties. In addition, there is the risk that the coating will become brittle and prone to fracture. The nominal electrical power of the mixing unit can vary in a wide range, e.g., from 0.1 kW to 1000 kW. Thus, it is possible to use mixing units on the laboratory scale with a nominal power of 0.1-5 KW or mixing units for the production scale with a nominal electrical power of 10-1000 KW. The nominal electrical power is the nameplate, maximal absolute electrical power of the mixing unit.

The volume of the mixing unit may vary in a wide range. For example, the volume of the mixing unit may range from 0.1 L to 2.5 m³. For example, mixing units on a laboratory scale may have a volume of 0.1-10 L or mixing units for the production scale may have a volume of 0.1-2.5 m³.

Preferably, in the process according to the invention, forced action mixers are used in the form of intensive mixers with high-speed mixing tools. It has been found that a speed of the mixing tool of 5-30 m/s, more preferably of 10-25 m/s, gives the best results. Examples of commercially available mixing units which are suitable for the process of the invention include Henschel mixers and Eirich mixers. The Eirich mixers may be, for example, high intensity Eirich mixers.

The mixing time may vary and may be preferably from 0.1 to 120 minutes, more preferably from 0.2 to 60 minutes, and most preferably from 0.5 to 10 minutes.

The mixing may be followed by a thermal treatment of the mixture for improved binding of the coating to the anode active material particles. However, this treatment is optional in the process according to the invention since in this process, the pyrogenically produced, nanostructured and surface modified magnesium oxide adheres with sufficient firmness to the core anode active material particles, i.e., the carbon and/or Si-based particles. Hence, a preferred embodiment of the process according to the invention may not include a thermal treatment after the mixing.

It has been found that the best results regarding the adhesion of the magnesium oxides to the core anode active material particles are obtained when the magnesium oxide has a BET surface area of 5 m²/g-300 m²/g, more preferably of 10 m²/g-200 m²/g and most preferably of 15-150 m²/g. The BET surface area can be determined according to DIN 9277:2014 by nitrogen adsorption according to the Brunauer-Emmett-Teller procedure.

### Pyrogenic Formation of MgO

The magnesium oxide used in the process according to the invention is produced pyrogenically, i.e., by a pyrogenic method. A pyrogenic method is also referred to as a “fumed” method. Such “pyrogenic” or “fumed” method involves the reaction of a corresponding metal precursor in a flame hydrolysis or a flame oxidation in an oxyhydrogen flame to form the metal oxide.

A pyrogenically prepared, hydrophilic magnesium oxide is characterized by:

| | |
|---|---|
| Surface area [m²/g] | 50 to 350 |
| Tamped density [g/L] | 20 to 100 |
| Drying loss [%] | less than 5 |
| Loss on ignition [%] | 0.1 to 20 |

The terms “pyrogenically produced or prepared”, “pyrogenic” and “fumed” are used equivalently in the context of the present invention. The fumed magnesium oxides may be prepared by means of flame hydrolysis or flame oxidation. This involves oxidizing or hydrolyzing of hydrolysable or oxidizable starting materials, generally in a hydrogen/oxygen flame. Starting materials typically used for pyrogenic methods include organic or inorganic substances, such as metal chlorides.

Thus, the hydrophilic magnesium oxide according to the present invention can be prepared by means of flame spray pyrolysis, wherein at least one solution of metal precursors, comprising a magnesium salt, a solvent e.g., ethanol, methanol or water is subjected to flame spay pyrolysis.

During the flame spray pyrolysis process, the solution of metal compounds (metal precursors) in the form of fine droplets is typically introduced into a flame, which is formed by ignition of a fuel gas and an oxygen-containing gas, where the used metal precursors are oxidized and/or hydrolyzed to give the corresponding magnesium oxide.

This reaction initially forms highly disperse approximately spherical primary particles, which in the further course of the reaction coalesce to form aggregates. The aggregates can then accumulate into agglomerates. In contrast to the agglomerates, which as a rule can be separated into the aggregates relatively easily by introduction of energy, the aggregates are broken down further, if at all, only by intensive introduction of energy. Said metal oxide powder may be partially destructed and converted into nanometre (nm) range particles advantageous for the present invention by suitable grinding.

The produced aggregated compound can be referred to as “fumed” or “pyrogenically produced” magnesium oxide.

The flame spray pyrolysis process is in general described in WO 2015173114 A1 and elsewhere.

The inventive flame spray pyrolysis process preferably comprises the following steps:
a) the solution of metal precursors is atomized to afford an aerosol by means of an atomizer gas,
b) the aerosol is brought to reaction in the reaction space of the reactor with a flame obtained by ignition of a mixture of fuel gas and an oxygen-containing gas to obtain a reaction stream,
c) the reaction stream is cooled and
d) the solid magnesium oxide is subsequently removed from the reaction stream.

Metal precursors employed in the inventive process include magnesium salts such as magnesium chloride, magnesium nitrate or magnesium acetate.

The solvent of this solution can be all typical solvents such as water, ethanol, methanol and others.

The amount of metal precursors in the solution may range of from 5 to 80 wt. %, preferably of from 20 to 70 wt. %, based on the total weight of the solution.

Examples of fuel gases are hydrogen, methane, ethane, natural gas and/or carbon monoxide. It is particularly preferable to employ hydrogen.

The oxygen-containing gas is generally air or oxygen-enriched air. An oxygen-containing gas is employed in particular for embodiments where for example a high BET surface area of the magnesium oxide to be produced is desired. The total amount of oxygen is generally chosen such that, it is sufficient at least for complete conversion of the fuel gas and the metal precursors.

For obtaining the aerosol, the vaporized solution containing metal precursors can be mixed with an atomizer gas, such as nitrogen, air, and/or other gases. The resulting fine droplets of the aerosol preferably have an average droplet size of 1-120 μm, particularly preferably of 30-100 μm. The droplets are typically produced using single- or multi-material nozzles. To increase the solubility of the metal precursors and to attain a suitable viscosity for atomization of the solution, the solution may be heated.

The particle size of the magnesium oxides can be varied by means of the reaction conditions, such as, for example, flame temperature, hydrogen or oxygen proportion, magnesium salt quantity, residence time in the flame, or length of the coagulation zone.

The used metal oxide precursors may be atomized dissolved in water or an organic solvent. Suitable organic solvents include methanol, ethanol, n-propanol, isopropanol, n-butanol, tert-butanol, 2-propanone, 2-butanone, diethyl ether, tert-butyl methyl ether, tetrahydrofuran, C1-C8-carboxylic acids, ethyl acetate, toluene, petroleum and mixtures thereof.

Thus, the pyrogenically produced, nanostructured and, preferably, surface modified magnesium oxide used in the process according to the invention, is in the form of aggregated primary particles, preferably with a numerical mean aggregate diameter of 5-150 nm, more preferably 10-120 nm, even more preferably 20-100 nm, as determined by transition electron microscopy (TEM). This numerical mean diameter can be determined by calculating the average size of at least 500 particles analysed by TEM.

The mean diameter of the agglomerates is usually 1-2 μm. These mean numerical values can be determined in a suitable dispersion, e.g., in an aqueous dispersion, by a static light scattering (SLS) method. The agglomerates and partly the aggregates can be destroyed e.g., by grinding or ultrasonic treatment of the particles to result in particles with a smaller particle size.

The mean aggregate diameter d₅₀ of the metal oxide is 5-150 nm, more preferably 10-120 nm, even more preferably 20-100 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

Thus, the pyrogenically produced, nanostructured and preferably surface modified magnesium oxide used in the process of the present invention is preferably characterized by high dispersibility, that is, the ability to form relatively small particles under mild ultrasonic treatment. It is believed, that dispersion under such mild conditions correlates with the conditions during the dry coating process. That means, the agglomerates of the magnesium oxide are destroyed in the mixing process of the present invention in a similar way as under the ultrasonic treatment and are able to form a homogeneous coating of the anode active material particles.

The span (d₉₀−d₁₀)/d₅₀ of particles of the magnesium oxide is preferably 0.4-1.2, more preferably 0.5-1.1, and even more preferably 0.6-1.0, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

Thus, the pyrogenically produced, nanostructured magnesium oxide used in the process of the present invention is preferably characterized by a relatively narrow particle size distribution. This helps to achieve a high-quality magnesium oxide coating on the surface of the anode material particles.

The d values d₁₀, d₅₀ and deo are commonly used for characterizing the cumulative particle diameter distribution of a given sample. For example, the d₁₀ diameter is the diameter at which 10% of a sample's volume is comprised of smaller than d₁₀ particles, the d₅₀ is the diameter at which 50% of a sample's volume is comprised of smaller than d₅₀ particles. The d₅₀ is also known as the “volume median diameter” as it divides the sample equally by volume; the do is the diameter at which 90% of a sample's volume is comprised of smaller than deo particles.

The pyrogenically produced magnesium oxide is hydrophilic. Through surface modification of the pyrogenically produced magnesium oxide, a hydrophobic magnesium oxide is then produced. The surface treatment may include using any of many suitable hydrophobic reagents, such as silanes. Both the hydrophilic and the hydrophobic forms of the fumed, nanostructured magnesium oxide may be used as coatings using the process of the present invention via dry mixing with the substrate active anode material. However, the fumed, nanostructured, and surface modified hydrophobic magnesium oxide is preferred because it shows a more homogeneous coverage of the substrate active anode material and a full coverage of the substrate active anode material.

### Surface Treatment of the Pyrogenically Produced MgO.

The pyrogenically produced MgO without any further surface treatment is hydrophilic because it is naturally covered with hydroxyl (—OH) groups. However, through surface modification of the pyrogenically produced MgO, hydrophobic MgO is also produced. For example, hydrophobization of the MgO may be performed by reacting the hydroxyl groups with a silane to form —O—Si—R groups. Thus, preferably, the MgO is surface modified, meaning that the surface of the MgO is at least partially covered by silanes.

The pyrogenically produced MgO may be used in its hydrophilic and hydrophobic forms. The use of the hydrophilic MgO does not require any further treatment after synthesis by the pyrogenic process. However, after synthesis by the pyrogenic process, by further treatment with a hydrophobic reagent, such as, for example, silanes, the MgO particles can become hydrophobic. For example, in an embodiment, an octyl silane is covalently bound to the surface of the MgO particles. Both the hydrophilic and the hydrophobic forms of the fumed, nanostructured MgO may be used effectively as coatings using the process of the present invention via dry mixing with the substrate active anode material. The fumed, nanostructured and surface modified MgO is preferred because it shows more homogeneous coverage of the substrate active anode material.

In an embodiment, a pyrogenically prepared, surface modified magnesium oxide, is produced which is characterized by:

| | |
|---|---|
| Surface area [m²/g] | 50 to 350 |
| Tamped density [g/L] | 20 to 100 |
| Drying loss [%] | less than 5 |
| Loss on ignition [%] | 0.1 to 20 |

Accordingly, the pyrogenically prepared magnesium oxide is sprayed with a surface modifying agent at room temperature and the mixture is subsequently treated thermally at a temperature of 50 to 300° C., preferably 80-180° C., over a period of 0.5 to 3 hours (“h”).

In an alternative embodiment, surface modification of the pyrogenically prepared magnesium oxide can be carried out by treating the pyrogenic magnesium oxide with a surface modifying agent in vapor form and subsequently treating the mixture thermally at a temperature of 50 to 800° C. over a period of 0.5 to 6 h.

An alternative method for surface modification of the pyrogenically prepared magnesium oxide can be carried out by treating the pyrogenic magnesium oxide with a surface modifying agent in vapor form and subsequently treating the mixture thermally at a temperature of 50 to 800° C. over a period of 0.5 to 6 h.

The thermal treatment can be conducted under protective gas, such as, for example, nitrogen. The surface treatment can be carried out in heatable mixers and dryers with spraying devices, either continuously or batchwise. Suitable devices can be, for example, plowshare mixers or plate, cyclone, or fluidized bed dryers.

The present invention has the advantage that commercially available silanes can be used to modify magnesium oxide and thus individually adapt the properties of magnesium oxide, depending on the desired properties and intended purposes.

As surface modifying agent, it is possible to employ the following compounds and mixtures of the following compounds:
a) Organosilanes of the type (RO)₃Si(CₙH₂ₙ₊₁) and (RO)₃Si(CₙH₂ₙ₋₁), wherein R=alkyl, such as, for example, methyl, ethyl, n propyl, i-propyl, butyl, and n=1-20
b) Organosilanes of the type R′ₓ(RO)_{y}Si(CₙH₂ₙ₊₁) and R′ₓ(RO)_{y}Si(CₙH₂ₙ₋₁) wherein
R=alkyl, such as, for example, methyl-, ethyl-, n-propyl-, i-propyl-, butyl-
R′=alkyl, such as, for example, methyl, ethyl, n-propyl, i-propyl, butyl
R′=cycloalkyl

$$n = 1 - 20$$

$$x + y = 3$$

$$x = 1 , 2 , and$$

$$y = 1 , 2$$

c) Halogen organosilanes of the type X₃Si(CₙH₂ₙ₊₁) and X₃Si(CₙH₂ₙ₋₁), wherein

$$X = Cl , Br$$

$$n = 1 - 20$$

d) Halogen organosilanes of the type X₂(R)Si(CₙH₂ₙ₊₁) and X₂(R′)Si(CₙH₂ₙ₋₁), wherein
X=Cl, Br
R′=alkyl, such as, for example, methyl, ethyl, n-propyl, i-propyl, butyl
R′=cycloalkyl

$$n = 1 - 20$$

e) Halogen organosilanes of the type X(R′)₂Si(CₙH₂ₙ₊₁) and X(R′)₂Si(CₙH₂ₙ₋₁), wherein
X=Cl, Br
R′=alkyl, such as, for example, methyl, ethyl, n-propyl, i-propyl, butyl
R′=cycloalkyl

$$n = 1 - 20$$

f) Organosilanes of the type (RO)₃Si(CH₂)ₘ—R′
R=alkyl, such as methyl, ethyl, propyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR′R″R′″ wherein
R′=alkyl, aryl;
R″=H, alkyl, aryl;
R″=H, alkyl, aryl, benzyl, C₂H₄NR″″R′″″ with R″″=H, alkyl and
R′″″=H, alkyl
g) Organosilanes of the type (R″)ₓ(RO)_{y}Si(CH₂)ₘ—R′
R″=alkyl

$$x + y = 2$$

$$= cycloalkyl \times = 1.2$$

$$y = 1.2$$

$$m = 0.1 to 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR′R″R′″ wherein
R′=alkyl, aryl;
R″=H, alkyl, aryl;
R′″=H, alkyl, aryl, benzyl, C₂H₄NR″″R′″″ with R″″=H, alkyl and
R′″″=H, alkyl
h) Halogen organosilanes of the type X₃Si(CH₂)ₘ—R′
X=Cl, Br

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH
i) Halogen organosilanes of the type (R)X2Si(CH₂) m-R′
X=Cl, Br
R=alkyl, such as methyl, ethyl, propyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH,
j) Halogen organosilanes of the type (R)2XSi(CH2)m-R′
X=Cl, Br
R=alkyl

$$m = 0.1 - 20$$

R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH

Preferably, as surface modifying agent, the following silanes are employed, either individually or in a mixture: dimethyldichlorosilane, octyltrimethoxysilane, oxtyltriethoxysilane, hexamethyldisilazane, 3 methacryloxypropyltrimethoxysilane, 3 methacryloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nanofluorohexyltrimethoxysilane, tridecafluorooctyltrimethoxysilane, tridecafluorooctyltriethoxysilane, aminopropyltriethoxysilane. Especially preferably, octyltrimethoxysilane and octyltriethoxysilane can be employed.

The MgO particles produced via the pyrogenic process usually have a purity of at least 96% by weight, preferably at least 98% by weight, more preferably at least 99% by weight. The magnesium oxide used in the inventive process preferably contains the elements Cd, Ce, Fe, Na, Nb, P in proportions of <10 ppm and the elements Ba, Bi, Cr, K, Mn, Sb in proportions of <5 ppm, where the sum of the proportions of all of these elements is <100 ppm. The proportion of carbon in hydrophilic, non-surface-modified metal oxides is preferably less than 0.2% by weight, more preferably 0.005%-0.2% by weight, even more preferably 0.01%-0.1% by weight, based on the mass of the metal oxide powder.

### Active Anode Material

The substrate anode particles which are encapsulated or coated with the fumed MgO may include any suitable material used as anode active material in secondary lithium-ion batteries, capable of reversible intercalating/deintercalating lithium ions and/or reversible reaction with lithium species. Examples thereof are carbonaceous materials including crystalline carbon such as natural or artificial graphite in the form of plate-like, flake, spherical or fibrous type graphite; amorphous carbon, such as soft carbon, hard carbon, mesophase pitch carbide, fired coke and the like, or mixtures thereof. In addition, Si-based particles can be used as anode active materials. Preferred anode active materials are carbon and/or Si-based particles. Si-based particles includes silicon particles (e.g., pure silicon particles), silicon oxide (SiOx) particles, and any combinations of silicon, silicon oxide, and carbon particles including mixtures and composites thereof. Silicon oxide can be SiO and/or SiO₂. In an embodiment, the active anode material may be a nanostructured porous silicon material. In an embodiment, the anode material is SiOx where x can vary from 0 to about 2, such as, Si, SiO, SiO₂ or any combinations thereof.

Preferred anode active materials are carbon and/or Si-based particles, including a composite material of C and Si-based particles. “Composite material” refers to a composition comprising both carbon material and silicon material. The carbon and silicon material may be a mixture of a carbon powder and a silicon powder of nano sized particles. In an embodiment the composite material may comprise individual particles of carbon and silicon which are chemically bonded. In another embodiment, the composite material may comprise porous, nanosized silicon particles with carbon impregnated within the silicon porous structure.

The active anode material which is mixed and coated with the metal oxide may comprise carbon and/or Si-based particles. In some embodiments, the active anode material may comprise a composite SiOx/C material wherein x can vary from 0 to about 2, made of 60-99% carbon and 40-1% silicon oxide, preferably 70-95% carbon and 30-5% silicon oxide, and more preferably 80-90% carbon and 20-10% silicon oxide. The composite SiOx/C material may be in the form of powder or particles.

In an embodiment, the active anode material may comprise a composite SiO/C material, made of 60-99% carbon and 40-1% SiO, preferably 70-95% carbon and 30-5% SiO, and more preferably 80-90% carbon and 20-10% SiO. The composite SiO/C material may be in the form of powder or particles.

In some embodiments, the active anode material may comprise a composite Si/C material, made of 60-99% carbon and 40-1% silicon, preferably 70-95% carbon and 30-5% silicon, and more preferably 80-90% carbon and 20-10% silicon. The composite Si/C material may be in the form of powder or particles.

The coated active anode material has a numerical mean particle diameter of 1-50 μm, preferably of 1-40 and more preferably of 2-20 μm. A numerical mean particle diameter can be determined according to ISO 13320:2009 by laser diffraction particle size analysis.

The active anode material may be referred to also as the core active anode material or the substrate active anode material or particles. The MgO may also be referred as the coating and the mixed active anode material with the coating may also be referred to as the coated active anode material or particles.

The proportion of the magnesium oxide in the coated mixed anode material is preferably 0.05%-5% by weight, more preferably 0.1%-2% by weight, based on the total weight of the coated mixed anode material. If the proportion of the magnesium oxide is less than 0.05% by weight, no beneficial effect of the coating can usually be observed yet. In the case of more than 5% by weight thereof, no beneficial effect of the additional quantity of the magnesium coating of more than 5% by weight is usually observed.

The coated mixed anode material preferably has a coating layer thickness of 10-200 nm, as determined by TEM analysis.

The present invention further provides a coated mixed anode material obtainable by the process according to the invention. The invention further provides a coated mixed anode material containing a pyrogenically produced, nanostructured and surface modified magnesium oxide coating on the surface of the anode active material particles.

The further preferred features of the coated mixed anode material, of the pyrogenically produced, nanostructured and surface modified magnesium oxide described above in the preferred embodiments of the process according to the present invention are also the preferred features of the coated mixed anode material, the pyrogenically produced, nanostructured and surface modified magnesium oxide, in respect to the coated mixed anode material according to the present invention, independent on whether it is produced by the inventive process or not.

The invention further provides an active negative electrode material for a lithium-ion battery comprising the coated anode material according to the invention or the coated anode material obtainable by the process according to the invention.

The negative electrode, i.e., the anode of the lithium-ion battery includes a current collector and the coated active anode material particles formed over or on the current collector. The current collector may be, for example, an aluminium foil, copper foil, a nickel foil, a stainless-steel foil, a titanium foil, a polymer substrate coated with a conductive metal, or a combination thereof.

The invention also provides a lithium-ion battery comprising the coated anode material or the coated anode material obtainable by the process according to the invention.

The lithium-ion battery of the invention, apart from the anode, may also comprise a cathode, optionally a separator and an electrolyte comprising, for example, a lithium salt or a lithium compound.

The cathode of the lithium-ion battery may comprise any suitable material, commonly used in the secondary lithium-ion batteries, capable of reversible intercalating/deintercalating lithium ions.

The cathode material used with preference in the process according to the invention is selected from the group consisting of lithium-cobalt oxide, lithium-manganese oxide, lithium-nickel-cobalt oxides, lithium-nickel-manganese-cobalt oxides, lithium-nickel-cobalt-aluminium oxides, lithium-nickel-manganese oxides, and a mixture thereof

The electrolyte of the lithium-ion battery can be in the liquid, gel or solid form. The liquid electrolyte of the lithium-ion battery may comprise any suitable organic solvent commonly used in the lithium-ion batteries, such as anhydrous ethylene carbonate (EC), dimethyl carbonate (DMC), propylene carbonate, methylethyl carbonate, diethyl carbonate, gamma butyrolactone, dimethoxyethane, fluoroethylene carbonate, vinylethylene carbonate, and a mixture thereof

The gel electrolytes include gelled polymers. Any suitable gelled polymers may be used.

The solid electrolyte of the lithium-ion battery may comprise oxides, e.g., lithium metal oxides, sulfides, phosphates, or solid polymers.

The electrolyte of the lithium-ion battery can contain a lithium salt. Examples of such lithium salts include lithium hexafluorophosphate (LiPF₆), lithium bis 2-(trifluoromethylsulfonyl)imide (LiTFSI), lithium perchlorate (LiClO₄), lithium tetrafluoroborate (LiBF₄), Li₂SiF₆, lithium triflate, LIN (SO₂CF₂CF₃)₂ and mixtures thereof.

The invention further provides use of the coated anode material in an active negative electrode material of a lithium-ion battery.

Even without further explanations, it is assumed that a person skilled in the art can fully use the above description. The preferred embodiments and examples are therefore to be understood only as a descriptive, by no means as a limiting in any way.

In the following, the present invention is explained in more detail using examples. Alternative embodiments of the present invention are available in an analogous manner.

### EXAMPLES

### Determination of the Physical-Chemical Characteristic Data

In the context of the present invention the following measurement methods for evaluating the characteristics for the different materials were used:

### A) BET Surface Area:

The BET surface area is determined in accordance with DIN 9277:2014 with nitrogen.

### B) Tamped Density:

Determination of the tamped density in adaptation of DIN ISO 787/XI,

### Fundamentals of the Tamped Density Determination:

The tamped density (formerly the tamped volume) is equal to the quotient of the mass and the volume of a powder after tamping in the tamping volumeter under predetermined conditions. In accordance with DIN ISO 787/XI, the tamped density is given in g/cm³. Because of the very low tamped density of the oxides, however, the value is given in g/L by us. Furthermore, the drying and sieving as well as the repetition of the tamping operation is dispensed with.

### Apparatus for Tamped Density Determination:

Tamping volumeter
Volumetric cylinder
Laboratory scale (Reading to 0.01 g)

### Carrying Out the Tamped Density Determination:

200±10 mL of oxide is filled into the volumetric cylinder of the tamping volumeter in such a way that no pores remain, and the surface is level. The mass of the filled sample is determined precisely to 0.01 g. The volumetric cylinder with the sample is placed in the volumetric cylinder holder of the tamping volumeter and tamped 1250 times. The volume of the tamped oxide is read off 1 time exactly.

### Evaluation of the Tamped Density Determination

$$Tamped density ( \frac{g}{L} ) = \frac{g weighed quantity}{mL volume read off} \times 1000$$

### C) pH Value:

The pH value is determined in 4% aqueous dispersion for hydrophobic oxides in Water:methanol (1:1).

### Reagents for the pH Value Determination:

Distilled or completely deionized water, pH >5.5
Methanol, p.a.
Buffer solutions pH 7.00 pH 4.66

### Apparatus for pH Value Determination:

Laboratory scale, (Reading to 0.1 g)
Glass beaker, 250 mL
Magnetic stirrer
Magnetic rod, length 4 cm
Combined pH electrodes
pH measuring apparatus
Dispensers, 100 mL

### Working Procedure for the Determination of the pH Value:

The determination is conducted in adaptation of DIN/ISO 787/IX:
Calibration: Prior to the pH value determination, the measuring apparatus is calibrated with the buffer solutions. If several measurements are carried out in succession, a single calibration suffices.

4 g of hydrophilic oxide is stirred into a paste in a 250 mL glass beaker with 96 g (96 mL) of water by use of a dispenser and stirred for five minutes with a magnetic stirrer while the pH electrode is immersed (rpm approx. 1000 min⁻¹).

4 g of hydrophobic oxide is stirred into a paste in a 250 mL glass beaker with 48 g (61 mL) of methanol and the suspension is diluted with 48 g (48 mL) of water and stirred for five minutes with a magnetic stirrer while the pH electrode is immersed (rpm approx. 1000 min⁻¹). After the stirrer has been switched off, the pH is read off after a standing time of one minute. The result is given to within one decimal place.

### D) Drying Loss

In contrast to the weighed quantity of 10 g mentioned in DIN ISO 787 II, a weighed quantity of 1 g is used for the drying loss determination.

The cover is put in place prior to cooling. A second drying is not conducted.

Approx. 1 g of the sample is weighed precisely to 0.1 mg into a weighing dish with a ground cover that has been dried at 105° C., the formation of dust being avoided, and dried for two hours in the drying cabinet at 105° C. After cooling in a desiccator with its cover still on, the sample is reweighed under blue gel.

$$\% Drying loss at 105 ° C . = \frac{g weight loss}{g weighed quantity} \times 100$$

The result is given to within one decimal place.

### E) Loss on Ignition

### Apparatus for the Determination of the Loss on Ignition:

Porcelain crucible with crucible cover
Muffle furnace
Analysis scale (Reading to 0.1 mg)
Desiccator

### Carrying Out the Loss on Ignition:

In departure from DIN 55 921, 0.3-1 g of the undried substance is weighed to precisely 0.1 mg into a porcelain crucible with a crucible cover, which have been heated red hot beforehand, and heated red hot for 2 hours at 1000° C. in a muffle furnace. The formation of dust is to be carefully avoided. It has proven advantageous to place the weighed samples into the muffle furnace while the latter are still cold. Slow heating of the furnace prevents the creation of stronger air turbulence in the porcelain crucible. After 1000° C. has been reached, red-hot heating is continued for a further 2 hours. Subsequently, a crucible cover is put in place and the weight loss of the crucible is determined in a desiccator over blue gel.

### Evaluation of the Determination of the Loss on Ignition

Because the loss on ignition is determined relative to the sample dried for 2 h at 105° C., the following calculation formula results:

$$\% Loss of ignition = \frac{m 0 * \frac{100 - TV}{100} - {m}_{1}}{m 0 * \frac{100 - TV}{100}} * 100$$

m0=weighed quantity (g)
TV=drying loss (%)
m1=weight of the sample after being heated red hot (g)

The result is given to within one decimal place.

### F) Carbon Content

The carbon content is determined by elemental analysis using a LECO C744 instrument. The measurement principle is based on oxidizing the carbon in the sample to CO₂, which is then quantified by infrared detectors

### G) SEM Measurements

The energy dispersive X-ray spectroscopy (EDX) was conducted with a SEM. For the EDX mapping a representative area of the sample was used at a magnification of 1000×, the image width was 2048×1536 pixel (120 μm×90.1 μm) resulting in a pixel resolution of 0.059 μm. The mapping was recorded with an acceleration voltage of 20 kV. Subsequent to the measurement the elements present in the sample were determined using the sum-spectrum of the mapping. The threshold for image analysis was adjusted according to the semi-quantitative mass %-values of the respective element.

### Preparation of Magnesium Oxide

### Example 1: Preparation of the Pyrogenically Prepared Magnesium Oxide

1.89 Kilogram of an aqueous solution containing 1000 g of Mg(CH₃COO)₂*4H₂O was prepared. An aerosol of 2.5 kg/h of this dispersion and 15 Nm³/h of air was formed via a two-component nozzle and sprayed into a tubular reaction with a burning flame. The burning gases of the flame consisted of 8 Nm³/h of hydrogen and 30 Nm³/h of air. Additionally, 25 Nm³/h of secondary air was used. After the reactor the reaction gases were cooled down and filtered.

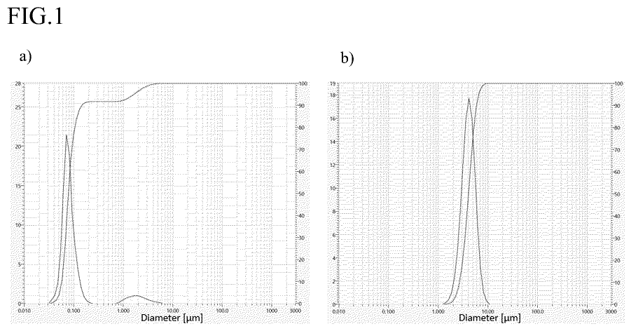

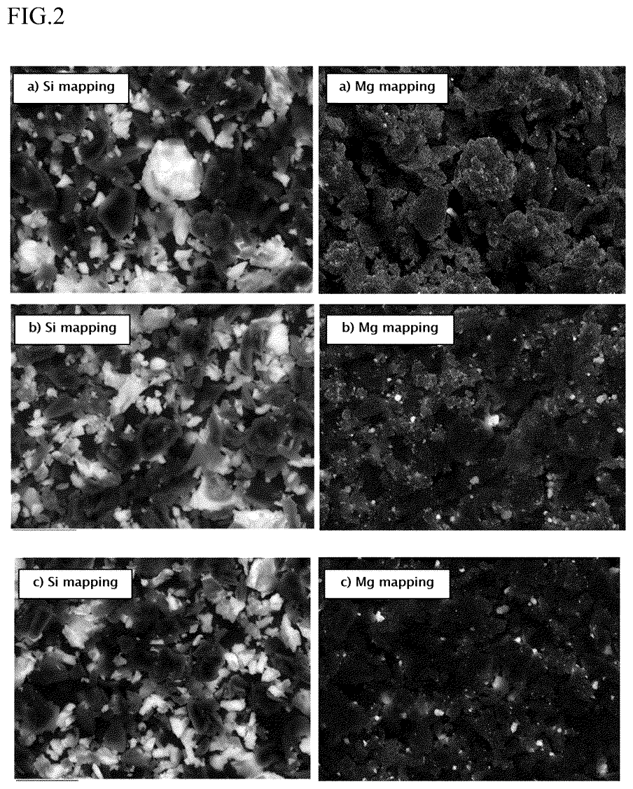

The particle properties are shown in Table 1, the TEM image of the particles is shown in FIG. 1 and the XRD analysis (FIG. 2) showed, that the major phase of the product was cubic magnesium oxide.

The high surface area, pyrogenically prepared hydrophilic magnesium oxide that forms has the physical-chemical characteristic data shown in Table I.

### Example 2: Preparation of Surface-Modified Magnesium Oxide

300 g of pyrogenically prepared magnesium oxide (example 1) are placed in a mixer and sprayed with 72 g octyltrimethoxysilane. After the spraying of the silane on the powder is finished, mixing is continued for additional 5 min. Then tempering of the wetted powder is carried out for 3 h at 130° C. in an oven. The surface modified magnesium oxide that forms has the physical-chemical characteristic data shown in Table I.

The hydrophilic and surface modified magnesium oxides have the physical-chemical characteristic data shown in Table 1.

TABLE 1

| Properties | Example 1 | Example 2 |
|---|---|---|
| BET [m²/g] | 240 | 225 |
| Tamped Density [g/L] | 56 | 78 |
| pH value | 10.5 | 10.2 |
| Drying loss [%] | 0.5 | 0.6 |
| Loss on ignition [%] | 12.2 | 17.6 |
| Carbon content [%] | 0.0 | 9.7 |

### Coated Anode Active Material Examples

### Starting Materials

### Dry Coating Additives:

The materials described above in examples 1 and 2 were used, i.e., the fumed magnesium oxide of Example 1 with a BET surface area of 250 m²/g and the fumed hydrophobic magnesium oxide of Example 2 with a BET surface area of 230 m²/g, Evonik Operations GmbH. The fumed hydrophobic magnesium oxide of Example 2 was made hydrophobic by subjecting it to hydrophobization treatment following the pyrogenic formation process as described above. Non-fumed magnesium oxide with BET surface area of 65 m²/g, purchased from Sigma-Aldrich, Germany was also used as a comparative example. The non-fumed magnesium oxide is not nanostructured, it is a milled material with isolated, non-aggregated particles.

### Anode Active Material:

Composite Si/C material, made of 86% by weight carbon and 14% by weight silicon, commercially available under the trademark DXB8 Shandong Gelon Lib Co., Ltd., China, hereinafter referred to as the Si86/C14 substrate anode active material (“Si86/C14_AAM”) powder or particles. The Si86/C14_AAM is a mixture of SiOx and carbon as shown by SEM analysis, and has the following characteristics.

| DXB8 | | | | TEST INSTRUMENT AND METHOD |
|---|---|---|---|---|
| % by weight | Carbon 86 | | Silicon 14 | |
| PSD | D₁₀ | | 7.0 ± 1.0 μm | MALVERN INSTRUMENTS LTD |
| | | | | MASTERSIZER 2000 |
| | D₅₀ | | 16.0 ± 2.0 μm | |
| | D₉₀ | | 30.0 ± 3.0 μm | |
| Moisture | ≤0.1% | | | SARTORIUS HN101-drying tracker |
| SSA (specific | ≤5.0 | m²/g | | SSA testing instrument |
| surface area) | | | | |
| TAP density | ≥0.8 | g/ml | | TAP density testing instrument |
| Capacity | ≥650 | mAh/g | | Half cell testing |

| | | |
|---|---|---|
| 1^{st} cycle | ≥88.0% | Half cell testing |
| efficiency | | |

### Example 3

The Si86/C14_AAM was mixed with the respective amount (1.0 wt %) of the fumed magnesium oxide of Example 1 in a high intensity laboratory mixer (SOMAKON mixer MP-GL with 0.5 L mixing unit). For homogenization of the two powders, the speed was increased step by step: 1 min 100 rpm, 1 min 200 rpm, 1 min 500 rpm. After homogenization, the mixing speed was further increased to 2000 rpm for 5 min to achieve the dry coating of the Si86/C14_AAM particles by the respective magnesium oxide additive. The Si86/C14_AAM particles were coated with a MgO-coating layer having a thickness of 10-200 nm, as determined by TEM analysis. The Si86/C14_AAM particles were coated with a homogeneous MgO-coating layer having a thickness of 20-200 nm, as determined by TEM analysis.

### Example 4

The procedure of Example 3 was repeated exactly with the only difference, that the surface modified MgO of Example 2 was used instead of the MgO of Example 1. The Si86/C14_AAM particles were coated with a MgO-coating layer having a thickness of 20-200 nm, as determined by TEM analysis. A homogeneous coating of the Si86/C14_AAM particles was achieved when using fumed hydrophobic magnesium oxide of Example 2 as coating additive with the MgO coating layer having a thickness of 20-200 nm on top of the SI86/C14_AAM particles.

### Comparative Example 5

The procedure of Example 3 was repeated exactly with the only difference, that the non-fumed magnesium oxide with BET surface area of 65 m²/g, purchased from Sigma-Aldrich powder was used instead of the fumed MgO of Example 1.

Homogenously coated active anode particles are achieved when using the fumed magnesium oxides of Examples 1 and 2 as coating additive with the coating layer having a thickness of 20-200 nm on top of the Si86/C14_AAM particles.

The particle size distribution for the hydrophilic magnesium oxides was measured to visualize the dispersibility behaviour during applying shear forces to the magnesium oxide agglomerates.

FIG. 1(a) shows the particle size distribution of the fumed MgO of Example 1 and FIG. 1(b) shows the particle size distribution of the non-fumed magnesium oxide used in Example 5, analysed by a laser diffraction particle size analyser. The x axis in FIG. 1 shows the diameter of the particles, the left y axis shows volume in % (“q %”), and the right y axis shows cumulative volume in (“Q %”).

The samples were dispersed in distilled water and treated for 15 minutes in an external ultrasonic bath (160 W). For the fumed MgO of Example 1, an almost mono-modally and very narrow particle size distribution was detected with small aggregate sizes of d10=58 nm, d50=78 nm, d90=147 nm. In the case of the non-fumed magnesium oxide, a slightly broader particle size distribution was detected with much larger agglomerate sizes of d10=2680 nm, d50=4080 nm, d90=5950 nm, clearly revealing the presence of non-dispersed particles.

### Analysis of the Coated Anode Materials by SEM-EDX

FIGS. 2 (2a, 2b, and 2c) shows the SEM-EDX (scanning electron microscope with energy dispersive X-ray) mapping of the different magnesium oxide coating additives on the Si86/C14_AAM particles (a: fumed hydrophobic MgO of Example 2, b: fumed MgO of Example 1, c: non-fumed magnesium oxide). On the left side of each of the FIGS. 2a, 2b, and 2c, the mapping of Si is shown to visualize the silicon distribution within the anode active material (mixture of carbon with silicon). This information helps when comparing with the Al/Ti distribution of the coating additives on the right side and nicely shows the interaction of the coating additives with the anode material surface. The mapping of the Si86/C14_AAM coated by the fumed hydrophobic magnesia (a) shows a fully and homogeneous coverage of MgO substantially around all of the anode particles (silicon rich as well as carbon rich). No large magnesium oxide agglomerates were detected, showing that the dispersion of nanostructured fumed hydrophobic magnesia was most effective. Additionally, no free unattached MgO particles next to the anode particles were found, indicating the strong interaction of the surface modified fumed magnesium oxide particles with the Si86/C14_AAM particle surface and therefore an excellent adhesion between the coating MgO layer and the substrate.

In comparison to the surface modified and therefore hydrophobic fumed magnesia, the hydrophilic fumed material of Example 1 shows a quite good dispersibility of the agglomerates, but preferably interacts with the Si-rich particles instead of the carbon-rich particles (b). Hence, the magnesia coating is more pronounced on the surfaces of the Si-rich particles. A few, non-dispersed and therefore free standing of the fumed hydrophilic MgO particles which are not coated on the Si86/C14_AAM particles exist next to the coated Si86/C14_AAM particles.

In contrast, by using coarser magnesia particles (non-fumed magnesium oxide) as coating for the Si86/C14_AAM particles (c), only a minor amount of the finer-sized MgO particles is attached to the surface of the Si86/C14_AAM particles. The larger, non-dispersed and therefore unattached MgO particles are located next to the Si86/C14_AAM particles many of which are not fully coated. As a result, the Si86/C14_AAM particles are not fully covered by this coarser, non-surface modified and non-fumed MgO particles.

Hence, the Si86/C14_AAM particles dry coated with fumed MgO, show a full and homogeneous coverage of all Si86/C14_AAM particles with MgO. No larger MgO agglomerates were detected, showing a good dispersibility of the nanostructured fumed MgO. Additionally, no free unattached MgO particles were found next to the Si86/C14_AAM particles. Surface modified (i.e., hydrophobic), fumed MgO of Example 2 shows more homogeneous coverage of both carbon rich and silicon rich substrate particles than non-surface modified fumed MgO.

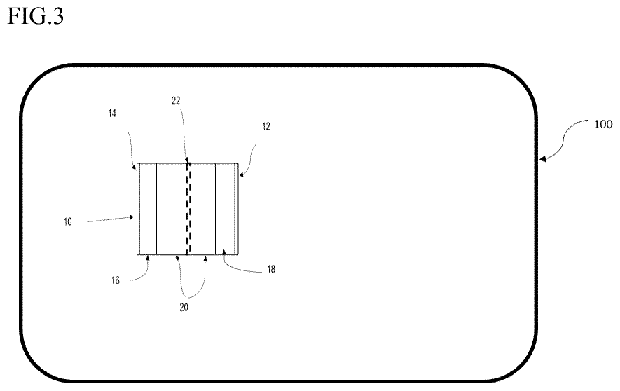

FIG. 3 shows a lithium-ion battery generally designated with numeral 10 inside an apparatus 100 powered by the lithium-ion battery 10 according to an embodiment of the present invention. The apparatus may be any electronic device such as, for example, a mobile phone, an electronic watch, a key fab, a laptop computer, a desktop computer, a computer pad and the like. The apparatus may also be an electrical apparatus such as a power tool, a vacuum cleaner, an electrical lawn mower, an electrical appliance, and the like. The lithium-ion battery 10 may be packaged in modules, each module having a plurality of lithium batteries 10, and used to power electric vehicles or hybrid vehicles. The lithium-ion battery 10 comprises negative and positive current collectors 14, and 12, a cathode 18 adjacent to the positive current collector 12, an anode adjacent to the negative current collector 14, an electrolyte 20 and a separator 22 disposed between the anode 16 and cathode 18. The anode 16 comprises a coated active anode material, characterized in that the coated active anode material is obtained by subjecting an active anode material and a pyrogenically produced, nanostructured magnesium oxide to dry mixing in a mixing unit. The active anode material is in the form of powder and comprises carbon particles, silicon particles, silicon oxide particles or any combinations thereof.

Although the present invention has been described in reference to specific examples it should be understood that the invention is not limited to these examples only and many variations thereof will fall within the scope of the invention as defined by the accompanying claims.

### LIST OF REFERENCE NUMERALS

10 battery cell
100 apparatus powered by battery cell
12 positive current collector
14 negative current collector
16 anode
18 cathode
20 electrolyte
22 separator

1. A process for producing a coated active anode material, the process comprising:
dry mixing an active anode material and a pyrogenically produced, nanostructured magnesium oxide, MgO, in a mixing unit under shearing conditions,
wherein the coated active anode material is in a form of particles, and the magnesium oxide has a BET surface area, DIN 9277:2014, of 5-300 m²/g, a mono-modally and narrow particle size distribution with a mean aggregate diameter d₅₀ of 5-150 nm, as determined by static light scattering (SLS) after 60 seconds of ultrasonic treatment at 25° C. of a mixture consisting of 5% by weight of the particles and 95% by weight of a 0.5 g/L solution of sodium pyrophosphate in water.

2. The process according to claim 1, wherein (i) the pyrogenically produced, nanostructured magnesium oxide is surface treated to become hydrophobic by reacting the hydroxyl groups of the MgO with a silane to form —O—Si—R groups prior to the dry mixing, and (ii) the mixing unit has a specific electrical power of 0.05-1.5 KW per kg of a mixed anode material.

3. The process according to claim 1, wherein the mean aggregate diameter d₅₀ is 10-120 nm, as determined by SLS after 60 seconds of ultrasonic treatment at 25° C. of a mixture consisting of 5% by weight of the particles and 95% by weight of a 0.5 g/L solution of sodium pyrophosphate in water.

4. The process according to claim 1, wherein the MgO is fully and homogeneously covered substantially around all anode particles, as determined by scanning electron microscopy with energy dispersive X-ray (SEM-EDX) mapping of the coated active anode material.

5. The process according to claim 1, wherein the specific electrical power of the mixing unit is 0.1-1000 KW, a volume of the mixing unit is 0.1 L to 2.5 m³, and a speed of a mixing tool in the mixing unit is 5-30 m/s.

6. The process according to claim 1, wherein a span (d₉₀−d₁₀)/d₅₀ of particles of the magnesium oxide is 0.4-1.2, as determined by SLS after 60 seconds of ultrasonic treatment at 25° C. of a mixture consisting of 5% by weight of the particles and 95% by weight of a 0.5 g/L solution of sodium pyrophosphate in water.

7. The process according to claim 1, wherein the active anode material is in a form of powder and comprises carbon particles, silicon particles, silicon oxide particles or any combinations thereof.

8. The process according to claim 1, further comprising:
subjecting the coated active anode material to a heat treatment following the dry mixing.

9. The process according to claim 1, wherein a proportion of the magnesium oxide in the coated active anode material is 0.05%-5% by weight, based on a total weight of a coated mixed anode material.

10. A coated active anode material, comprising:
an active anode material of carbon particles, silicon particles, silicon oxide particles or any combinations thereof, and
a coating of a pyrogenically produced, nanostructured magnesium oxide on a surface of a mixed anode material,
wherein the coated active anode material is in a form of particles, and the magnesium oxide has a BET surface area, DIN 9277:2014, of 5-300 m²/g, a mono-modally and narrow particle size distribution with a mean aggregate diameter d₅₀ of 5-150 nm, as determined by SLS after 60 seconds of ultrasonic treatment at 25° C. of a mixture consisting of 5% by weight of the particles and 95% by weight of a 0.5 g/L solution of sodium pyrophosphate in water.

11. The coated active anode material of claim 10, wherein the MgO is fully and homogeneously covered substantially around all anode particles, as determined by scanning electron microscopy with energy dispersive X-Ray (SEM-EDX) mapping of the coated active anode material.

12. The coated active anode material obtainable by the process according to claim 1.

13. An active negative electrode material for a lithium-ion battery comprising the coated active anode material according to claim 10.

14. A lithium-ion battery comprising the coated active anode material according to claim 10.

15. A method, comprising:
reversibly storing lithium ions, and/or
reversibly storing electrons
in an active negative electrode of a lithium-ion battery, wherein the active negative electrode material comprises the coated active anode material according to claim 10.

16. An apparatus, comprising:
the lithium-ion battery of claim 14, wherein the apparatus is an electric device or an electronic device.

17. The apparatus according to claim 16, wherein the apparatus is selected from the group consisting of an electronic watch, a key fab, a laptop computer, a desktop computer, a computer pad, a power tool, a vacuum cleaner, an electric lawn mower, an electric appliance, and an electric vehicle.
